(19) United States
(12) Patent Application Publication
(10) Pub. No.: US 2018/0268291 A1
(43) Pub. Date: Sep. 20, 2018

(54) SYSTEM AND METHOD FOR DATA MINING TO GENERATE ACTIONABLE INSIGHTS

(71) Applicant: Wipro Limited, Bangalore (IN)

(72) Inventors: Paul Turner, Flintshire (GB); Srikanth Teccum Rajagopal Vedagiri, Secunderabad (IN); Soma Ghosh, Kolkata (IN)

(21) Appl. No.: 15/463,940

(22) Filed: Mar. 20, 2017

(30) Foreign Application Priority Data
Mar. 14, 2017 (IN) 201741008797

(51) Int. Cl. G06N 3/08; G06F 17/30; G06N 5/04

(52) U.S. Cl. CPC G06N 3/08; G06N 5/04; G06F 17/30539

(57) ABSTRACT

This disclosure relates generally to data mining, and more particularly to system and method for mining data to generate actionable insights. In one embodiment, the method comprises receiving an input data and a target data, and detecting a defect in the target data using a neural network based predictive model and a scorecard rule table. The scorecard rule table comprises a plurality of scorecards corresponding to a plurality of nodes of the neural network. Each of the scorecards comprises a plurality of rules corresponding to a plurality of data variables in the input data. The method further comprises determining at least one root cause for the defect by determining at least one significant scorecard and at least one significant rule that contributed to the detection of the defect, and generating one or more actionable insights based on the at least one root cause.

This application claims the benefit of Indian Patent Application Serial No. 201741008797, filed Mar. 14, 2017, which is hereby incorporated by reference in its entirety.

### FIELD

This disclosure relates generally to data mining, and more particularly to system and method for mining data to generate actionable insights.

### BACKGROUND

In today's business world, companies are in a highly competitive global environment. For example, manufacturing industries and in particular those with discrete processes face stiff competition and strive for manufacturing excellence. Best-in-class performance on metrics such as production yield, production costs, throughput or cycle times, and product quality are deciding factors between those companies that thrive and those that fail. Typically, companies need to mine vast amounts of data that may be generated across their value chains, and identify actionable insights to improve these metrics so as to stride forward in their race for excellence.

However, many a times, companies are not able to extract value from data. For example, the companies are unable to keep up with the large volumes of data they are collecting so as to generate useful insights from it in a timely manner due to the resource and time intensive nature of such analysis. Further, the data is only understandable and useful to a limited number of trained observers. The companies lack the expertise necessary to analyze the data to generate actionable information.

The operations personnel in manufacturing production may like to identify primary causes of defects happening out of large number of potential causes in a timely manner so as to minimize the number of defects in production or improve product quality. The potential causes may include ‘known causes’ and ‘unknown causes’. ‘Known causes’ specific to the organization and their processes may be obtained from historical records or knowledge databases. However, ‘unknown causes’ may not be obtained from such historical records or knowledge databases as they have not been detected earlier. The ‘unknown causes’ may have happened but not been noticed due to unknown influences of a cause on the defect or the combination effect along with other identified causes. Additionally, interdependencies (correlation, or combined effects) of known causes and unknown causes are not effectively known.

Thus, there is a need for automating the process of mining data so as to identify defects and generate useful insights. A number of existing techniques provide for automation of data mining to at least some degree. Existing techniques improve defect identification by increasing accuracy (i.e., reducing number of ‘false positives’ and ‘false negatives’). For example, prediction models based on neural networks may predict or detect defects with higher accuracy (i.e., lower ‘false positives’ and ‘false negatives’). However, the requirements for defect detection is different for different industries. For example, in semiconductor manufacturing the actual defect rate may be required to be less than about 0.1% and therefore a ‘false positive’ rate of about 10% may be unacceptable.

Additionally, identification of appropriate root causes is a challenge, thereby limiting effective decision making by the operator. Existing techniques to perform accurate defect detection are less useful in providing interpretable (i.e., human understandable) information on root causes of the defects. Further, existing techniques to derive accurate interpretable information impacts the accuracy of defect detection by the prediction models. For example, accurate models such as neural network based models are not interpretable, and the interpretable models such as decision tree based models lack sufficient accuracy. Further, current attempts to extract interpretable information from accurate models such as neural network based models have interfered with the approximating capability of the model. For example, hidden Markov model based rule extraction for root-cause analysis brings down overall accuracy of the defect prediction by approximating the prediction made by the neural-network based models. Thus, there is a tradeoff between accuracy of the prediction models in detecting defects and the interpretability of the root causes for the defects. A lack of a mechanism for identification of appropriate root causes (maintaining both accuracy and interpretability) limits visibility (sense) of the manufacturing process problems.

### SUMMARY

In one embodiment, a method for mining data to generate actionable insights is disclosed. In one example, the method comprises receiving an input data and a target data from one or more sources. The method further comprises detecting a defect in the target data using a neural network based predictive model and a scorecard rule table. The scorecard rule table comprises a plurality of scorecards corresponding to a plurality of nodes of the neural network, and each of the plurality of scorecards comprises a plurality of rules corresponding to a plurality of data variables in the input data. The method further comprises determining at least one root cause for the defect by determining at least one significant scorecard of the plurality of scorecards and at least one significant rule in the at least one significant scorecard that contributed to the detection of the defect. The method further comprises generating one or more actionable insights based on the at least one root cause.

In one embodiment, a system for mining data to generate actionable insights is disclosed. In one example, the system comprises at least one processor and a memory communicatively coupled to the at least one processor. The memory stores processor-executable instructions, which, on execution, cause the processor to receive an input data and a target data from one or more sources. The processor-executable instructions, on execution, further cause the processor to detect a defect in the target data using a neural network based predictive model and a scorecard rule table. The scorecard rule table comprises a plurality of scorecards corresponding to a plurality of nodes of the neural network, and each of the plurality of scorecards comprises a plurality of rules corresponding to a plurality of data variables in the input data. The processor-executable instructions, on execution, further cause the processor to determine at least one root cause for the defect by determining at least one significant scorecard of the plurality of scorecards and at least one significant rule in the at least one significant scorecard that contributed to the detection of the defect. The processor-executable instructions, on execution, further cause the processor to generate one or more actionable insights based on the at least one root cause.

In one embodiment, a non-transitory computer-readable medium storing computer-executable instructions for mining data to generate actionable insights is disclosed. In one example, the stored instructions, when executed by a processor, cause the processor to perform operations comprising receiving an input data and a target data from one or more sources. The operations further comprise detecting a defect in the target data using a neural network based predictive model and a scorecard rule table. The scorecard rule table comprises a plurality of scorecards corresponding to a plurality of nodes of the neural network, and each of the plurality of scorecards comprises a plurality of rules corresponding to a plurality of data variables in the input data. The operations further comprise determining at least one root cause for the defect by determining at least one significant scorecard of the plurality of scorecards and at least one significant rule in the at least one significant scorecard that contributed to the detection of the defect. The operations further comprise generating one or more actionable insights based on the at least one root cause.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for mining data to generate actionable insights in accordance with some embodiments of the present disclosure.

FIG. 2 is a functional block diagram of an exemplary data mining engine in accordance with some embodiments of the present disclosure.

FIG. 3 is a flow diagram of an exemplary process for mining data to generate actionable insights in accordance with some embodiments of the present disclosure.

FIG. 4 is a flow diagram of an exemplary process for generating scorecard rule table in accordance with some embodiments of the present disclosure.

FIG. 5 is a flow diagram of an exemplary process for categorizing binary variables in accordance with some embodiments of the present disclosure.

FIG. 6 is a flow diagram of an exemplary process for categorizing categorical or nominal variables in accordance with some embodiments of the present disclosure.

FIG. 7 is a flow diagram of an exemplary process for categorizing interval or continuous variables in accordance with some embodiments of the present disclosure.

FIG. 8 is a schematic of a neural network based predictive model for generating scorecard rule table in accordance with some embodiments of the present disclosure.

FIG. 9 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

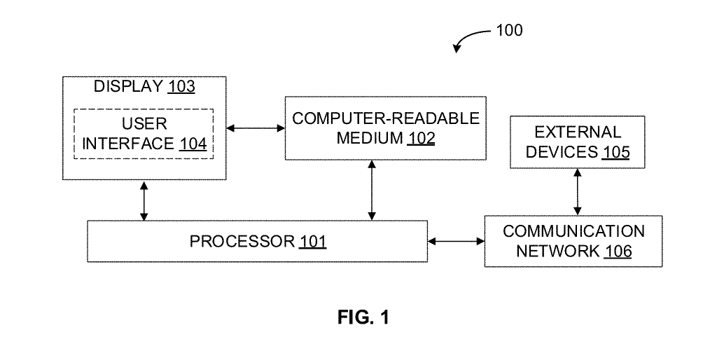

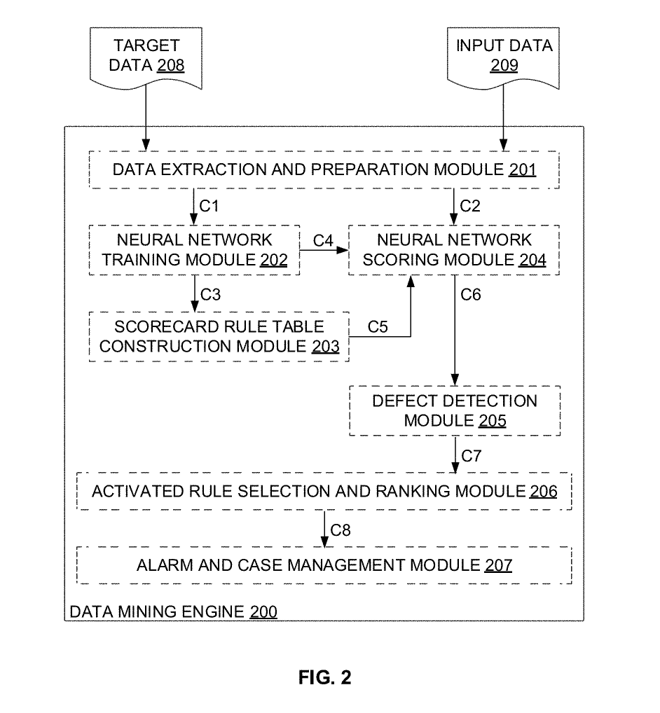

Referring now to FIG. 1, an exemplary system or data mining computing device 100 for mining data to generate actionable insights is illustrated in accordance with some embodiments of the present disclosure. In particular, the system 100 implements a data mining engine to generate actionable insights. As will be described in greater detail in conjunction with FIG. 2, the data mining engine comprises multiple modules configured to mine data so as to accurately detect defects and provide root cause analysis for the detected defects in an interpretable manner. For example, the data mining engine receives an input data and a target data, detects a defect in the target data using a neural network based predictive model and a scorecard rule table, determines at least one root cause for the defect by determining at least one significant scorecard and at least one significant rule that contributed to the detection of the defect, and generates one or more actionable insights based on the at least one root cause. The scorecard rule table comprises multiple scorecards corresponding to multiple nodes of the neural network. Each of the scorecards comprises multiple rules corresponding to various data variables in the input data.

The system 100 comprises one or more processors 101, a computer-readable medium (e.g., a memory) 102, and a display 103. The computer-readable storage medium 102 stores instructions that, when executed by the one or more processors 101, cause the one or more processors 101 to mine data to generate actionable insights in accordance with aspects of the present disclosure. For example, the computer-readable storage medium 102 may store a set of instructions corresponding to various modules for deriving a predictive model and a scorecard rule table, detecting a defect in the target data, determining at least one root cause for the defect, and generating actionable insights, and so forth. The one or more processors 101 may fetch the instructions from the computer-readable storage medium 102 via a wired or wireless communication path, and execute them to mine data to generate actionable insights.

The computer-readable storage medium 102 may also store various data (e.g., input data, target data, training data, predictive model, scores, score order, classification of data variables, categorization of data variables, scorecard rule table, defects, significant scorecard, significant rule, pre-defined thresholds, root cause analysis for the defects, actionable insights, etc.) that may be captured, processed, and/or required by the system 100. The system 100 interacts with a user via a user interface 104 accessible via the display 103. The system 100 may also interact with one or more external devices 105 over a communication network 106 for sending or receiving various data (e.g., training data, input data, target data, defects, root cause analysis, actionable insights, etc.). For example, the system 100 may receive input data as well as target data from the external device 105 and provide report on detected defects, root cause analysis for the defects, and appropriate actionable insights to the external device. The external devices 105 may include, but are not limited to, a desktop system, a remote server, a digital device, or any other computing system.

Referring now to FIG. 2, a functional block diagram of the data mining engine 200 implemented by the system 100 of FIG. 1 is illustrated in accordance with some embodiments of the present disclosure. The data mining engine 200 may include various modules that perform various functions so as to detect defects, perform root cause analysis, and provide actionable insights. In some embodiments, the data mining engine 200 comprises a data extraction and preparation module 201, a neural network based predictive model training module 202, a scorecard rule table construction module 203, a neural network based predictive model scoring module 204, a defect detection module 205, an activated rule selection and ranking module 206, and an alarm and case management module 207.

The data extraction and preparation module 201 acquires a target data 208 as well as an input data 209 from various data sources. In some embodiments, the input data 209 comprises a number of input variables, and each of the input variables comprises a number of input data elements (also referred to as input data samples). It should be noted that the target data 209 may include a target variables with respect to which defects may be detected, and root cause analysis may be performed. In other words, the target variables are specified variables, and represents an objective for some of the defect evaluations. The input data may be archived data (i.e., data collected over a time period) or real-time data for training the data mining engine 200 or for generating actionable insights by the data mining engine 200. Further, in some embodiments, the data extraction and preparation module 201 may implement an automated or a user-defined key model input-variable selection capability.

Additionally, the data extraction and preparation module 201 may integrate structured and unstructured data from multiple sources using Schema and extract, transform, load (ETL) tools. In some embodiments, the data extraction and preparation module 201 joins or aligns data into a single coherent data table utilizing joining keys, component genealogy, time-series mapping, and so forth. Further, in some embodiments, cleans data by removing missing data elements, corrupted data elements, and user-confirmed outliers.

The data received by the data extraction and preparation module 201 may be passed to the neural network based predictive model training module 202 via a data path C1. The neural network based predictive model comprises an output layer as well as at least one hidden layer, and predicts the target variable defect status from the input data variables. The output layer includes at least one output node while each of the at least one hidden layer includes at least one hidden node. Each of the nodes of the neural network implements a sigmoidal activation function. The training module 202 trains the logistic neural network based predictive model using standard neural network training, testing and validation techniques. The training module 202 further provides a report on model performance criteria. In some embodiments, the performance criteria includes a confusion matrix and model performance key performance indicators (KPIs) such as precision, recall, F-Measure, and so forth.

The trained neural network based predictive model, as well as the input data may be passed to the scorecard rule table construction module 203 via a data path C3. The scorecard rule table construction module 203 derives rules and constructs a scorecard rule table for the neural network based predictive model. In some embodiments, the scorecard rule table comprises a scorecard corresponding to each hidden node of the neural network based predictive model. Each of the scorecards comprises a number of rules corresponding to input data variables.

In some embodiments, the scorecard rule table construction module 203 generates scores for input data variables using trained neural network based predictive model, and determines a score order (e.g., high, medium, low, etc.) for input data variables based on the corresponding scores at the output of each hidden node. The scorecard rule table construction module 203 further classifies input data variables into one of a data classification type (e.g. binary, nominal or categorical, interval or continuous, numerical, etc.), and categorizes the input data variables based on the corresponding classification types and the corresponding values. The scorecard rule table construction module 203 then generates the scorecard rule table based on the classification, the score order, and the categorization at each hidden node.

The neural network based predictive model scoring module 204 comprises a real-time predictive analytics model for generating scores from the target data based on the trained neural network based predictive model and the scorecard rule table. The target data may be passed to the neural network based predictive model scoring module 204 via a data path C2, while the trained neural network based predictive model and the scorecard rule table are passed to the neural network based predictive model scoring module 204 via data paths C4 and C5 respectively.

The output (i.e., the prediction or the score) of the neural network based predictive model scoring module 204 along with the trained neural network based predictive model, the scorecard rule table, and the input data may be passed to the defect detection module 205 (also referred to as incident triggering module 205) via a data path C6. The defect detection module 205 determines if the score is predicting a defect or yield excursion based on a pre-defined threshold. In some embodiments, if the prediction or the output score is greater than or equal to the predefined threshold (say, 0.7), then the defect detection module 205 detects a defect, and initiates the activated rule selection and ranking module 206. However, if the prediction or the output score is less than the predefined threshold, then the defect detection module 205 sends the data mining engine 200 into a hibernation mode until new data arrives.

Upon detection of the defect, the activated rule selection and ranking module 206 is initiated. The output (i.e., the prediction or the score) of the neural network based predictive model scoring module 204 along with the trained neural network based predictive model, the scorecard rule table, and the input data may be passed to the activated rule selection and ranking module 206 via a data path C7. The activated rule selection and ranking module 206 determines, from the neural network based predictive model parameters, significant scorecards and significant rules that resulted in or that contribute to the detection of the defect (i.e., high score of the neural network based predictive model scoring module 204). Thus, the activated rule selection and ranking module 206 determines which input data variables may be involved in causing the high score, which hidden node (and therefore scorecard) is most relevant to the high score for each input variable, which scorecard rule is most relevant to the high score for each input variable, and so forth. Further, the activated rule selection and ranking module 206 performs all necessary ranking of the input data variables, the scorecards, and the rules.

The statistics, rankings, rules, and root cause variable information generated by the activated rule selection and ranking module 206 may be passed to the alarm and case management module 207 via a data path C8. The alarm and case management module 207 handles the user interface (UI) and administrative function with respect to the defect (i.e., high score event or incident detected by the predictive model). For example, the alarm and case management module 207 raises an alarm or provides a notification to relevant stakeholders. Further, the alarm and case management module 207 communicates highest ranked rule violations and input variables (i.e., interpretable or human understandable rules) to the relevant stakeholders for effective troubleshooting. Additionally, the alarm and case management module 207 handles the follow-up administration of the event such as corrective action taken, case management history records, case closure capabilities, and so forth.

It should be noted that the data mining engine 200 may be implemented in programmable hardware devices such as programmable gate arrays, programmable array logic, programmable logic devices, and so forth. Alternatively, the data mining engine 200 may be implemented in software for execution by various types of processors. An identified engine of executable code may, for instance, comprise one or more physical or logical blocks of computer instructions which may, for instance, be organized as an object, procedure, function, module, or other construct. Nevertheless, the executables of an identified engine need not be physically located together, but may comprise disparate instructions stored in different locations which, when joined logically together, comprise the engine and achieve the stated purpose of the engine. Indeed, an engine of executable code could be a single instruction, or many instructions, and may even be distributed over several different code segments, among different applications, and across several memory devices.

As will be appreciated by one skilled in the art, a variety of processes may be employed for mining data to generate actionable insights. For example, the exemplary system 100 and the associated data mining engine 200 may mine data to generate actionable insights by the processes discussed herein. In particular, as will be appreciated by those of ordinary skill in the art, control logic and/or automated routines for performing the techniques and steps described herein may be implemented by the system 100 and the associated data mining engine 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

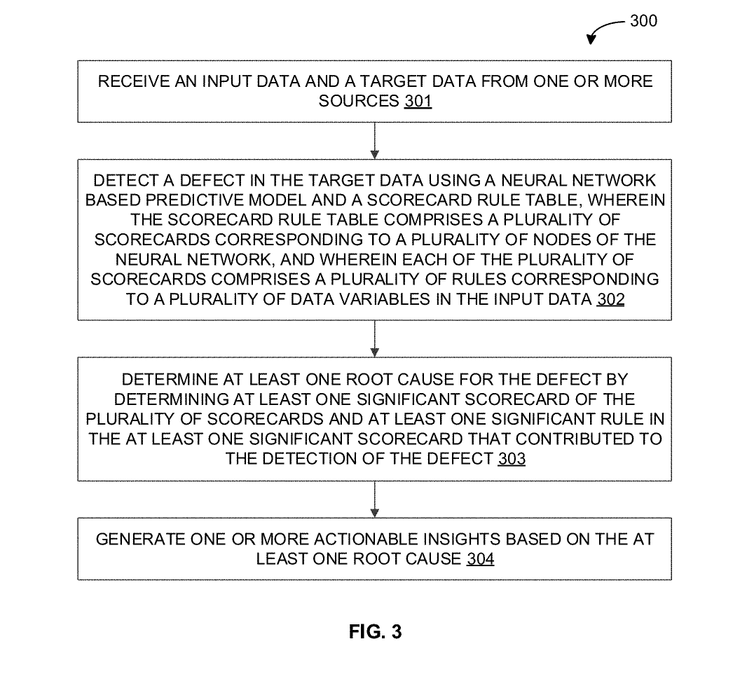

For example, referring now to FIG. 3, exemplary control logic 300 for mining data to generate actionable insights via a system, such as system 100, is depicted via a flowchart in accordance with some embodiments of the present disclosure. As illustrated in the flowchart, the control logic 300 includes the steps of receiving an input data and a target data from one or more sources at step 301, and detecting a defect in the target data using a neural network based predictive model and a scorecard rule table at step 302. The scorecard rule table comprises a plurality of scorecards corresponding to a plurality of nodes of the neural network. Further, each of the plurality of scorecards comprises a plurality of rules corresponding to a plurality of data variables in the input data. The control logic 300 includes the steps of determining at least one root cause for the defect by determining at least one significant scorecard of the plurality of scorecards and at least one significant rule in the at least one significant scorecard that contributed to the detection of the defect at step 803, and generating one or more actionable insights based on the at least one root cause at step 804. In some embodiments, the control logic 300 further includes the step of preparing the input data for data mining. Additionally, in some embodiments, the control logic 300 further includes the step of training the neural network based predictive model using a training data comprising a plurality of training data variables.

In some embodiments, the input data comprises a manufacturing operation data, and the defect comprises a component defect in the manufacturing operation. Additionally, in some embodiments, the neural network comprises a self-learning neural network comprising at least one hidden layer comprising at least one hidden node. Further, in some embodiments, each of the plurality of scorecards corresponds to a hidden node in the at least one hidden layer of the neural network. Moreover, in some embodiments, the neural network based predictive model comprises a linear sum of a plurality of logistic regression models, and an output layer comprising at least one output node.

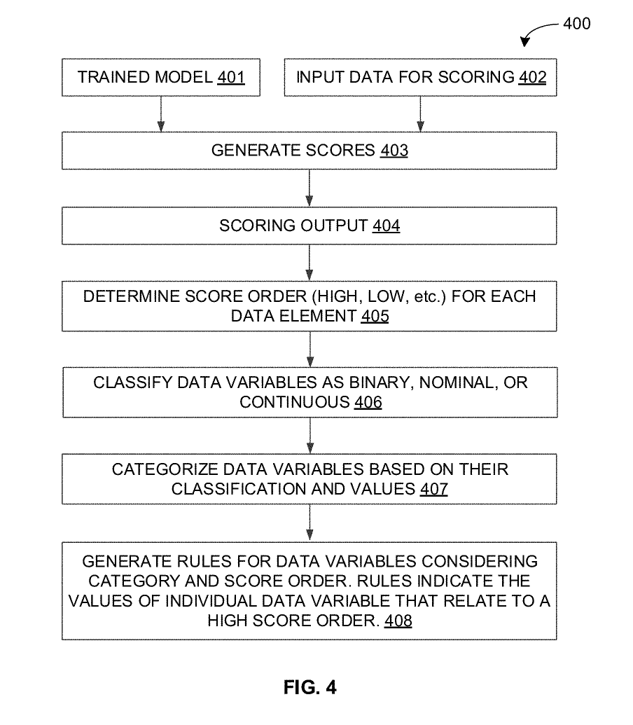

As will be described in greater detail in conjunction with FIG. 4, in some embodiments, the control logic 300 further includes the step of generating the scorecard rule table by generating a score, from the predictive model, for each of a plurality of data elements for each of the plurality of data variables, determining a score order for each of the plurality of data elements for each of the plurality of data variables based on the corresponding score, classifying each of the plurality of data variables into one of a data type (e.g., binary data variable, a nominal data variable, a continuous data variable, etc.), categorizing the plurality of data variables based on the classification and corresponding values, and generating the scorecard rule table based on the classification, the score order, and the categorization.

In some embodiments, detecting the defect at step 302 comprises determining if a score for an output parameter of the predictive model is greater than a pre-defined threshold. Additionally, in some embodiments, determining the at least one root cause at step 303 comprises determining the at least one significant scorecard of the plurality of scorecards and the at least one significant rule in the at least one significant scorecard that contributed in the score being greater than the pre-defined threshold. Further, in some embodiments, the at least one significant scorecard of the plurality of scorecards and the at least one significant rule in the at least one significant scorecard is determined from a plurality of coefficients of the neural network based predictive model. Moreover, in some embodiments, the one or more actionable insights comprise one or more recommendations to eradicate the defect or to improve an efficiency.

By way of example, the nonlinear scorecard and rule extraction technique considers a trained neural network as being the linear sum of individual logistic regression models which may then be passed through a final output layer node that also contains a sigmoidal activation function in order to limit the overall output of the model to be between 0 and 1. Thus, the example discussed here is based on a neural network architecture with a single hidden layer. However, as will be appreciated by those skilled in the art, the principles of the present disclosure may be easily extrapolated or adapted to a neural network with multiple hidden layers with little or no modifications. A general equation of a single linear logistic regression model is provided by equation (1), while the overall neural network based predictive model in the present context may be provided by equation (2) below:

$$\begin{matrix}P = \frac{1}{( 1 + exp ( - ( {\sum }_{i = 1}^{n} {w}_{i} {u}_{i}^{s} + β ) ) )} & ( 1 ) \\ P = \frac{1}{1 + exp ( - ( {\sum }_{j = 1}^{{n}_{h}} \frac{{v}_{j}}{( 1 + exp ( - ( {\sum }_{i = 1}^{{n}_{i}} {w}_{i , j} {u}_{i}^{s} + {β}_{j} ) ) )} + γ ) )} & ( 2 )\end{matrix}$$

In equation (2), nᵢ refers to the number of inputs, nₕ refers to the number of hidden nodes, Y is the output bias coefficient of the neural network, βⱼ is the bias coefficient on the j^{th} hidden note, wᵢⱼ is the coefficient weighting between the i^{th} input and the j^{th} hidden node, vⱼ is the coefficient weighting between the j^{th} hidden node and the output node, uᵢ^{E} is the input provided at i^{th} input node, and P is the output score of the predictive model.

Referring now to FIG. 4, exemplary control logic 400 for generating scorecard rule table for a trained, single, linear logistic regression model is depicted in greater detail via a flowchart in accordance with some embodiments of the present disclosure. As illustrated in the flowchart, the control logic 400 includes the steps of receiving trained model at step 401, receiving input data for scoring at step 402, generating scores for each of the data elements in each of the data variables using the trained model at step 403, and scoring the output at step 404.

The control logic 400 further includes the step of determining score order (i.e., high, low, medium, etc.) for each sample at step 405. First, one or more threshold values for each score order may be determined. It should be noted that the threshold values may be application dependent, or may depend on the objectives of the classification exercise. Further, the threshold values may be pre-defined, or provided by the user. For example, if the data is to be divided between high and low scores then a single threshold may be determined. The output score of the trained model above the threshold value may be considered as a classification of ‘high’, while the output score of the trained model below the threshold value may be considered as a classification of ‘low’. Thus, if the threshold value is 0.7, then the data is divided based on the output scores. Samples having a score greater than or equal to 0.7 are classified as ‘high’ while those scoring less than 0.7 are classified as low.

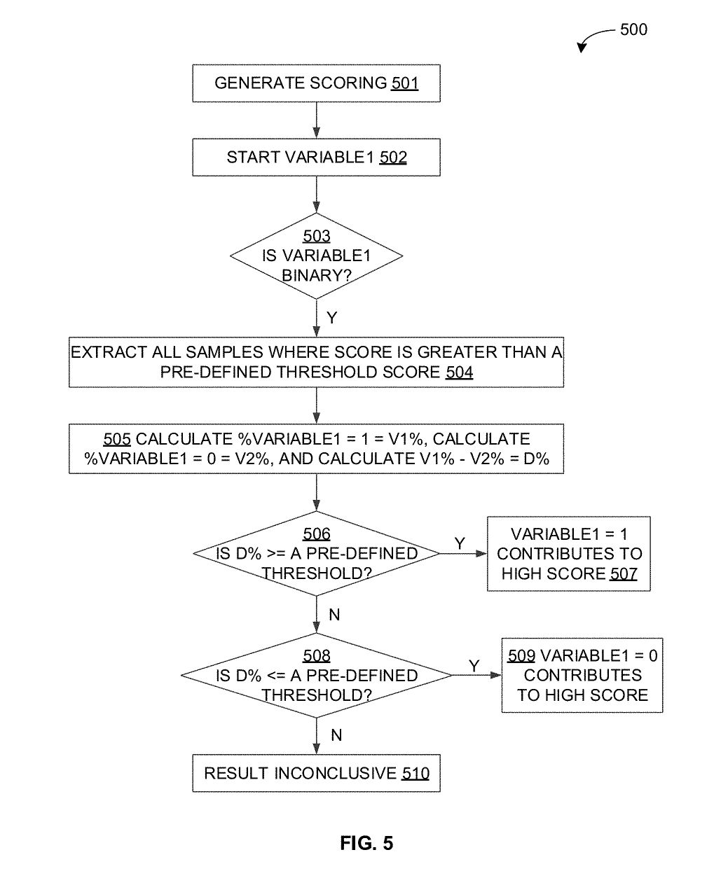

The control logic 400 further includes the step of classifying each of the input data variables based on its data type at step 406. In some embodiments, the data type may include a binary data variable, nominal or categorical data variable, interval or continuous data variable, numerical data variable, and so forth. The control logic 400 further includes the step of categorizing data variables based on their classification and values at step 407. As will be described in greater detail in conjunction with FIGS. 5-7, the categorization of the input variables is dependent on the data type as each data type requires a slightly different logic for categorization. The control logic 400 further includes the step of generating rules for data variables based on the categorization and the score order at step 408. As will be appreciated, in some embodiments, the rules indicate the values of individual variable that may relate to a high score order.

Referring now to FIG. 5, exemplary control logic 500 for categorizing binary variables is depicted in greater detail via a flowchart in accordance with some embodiments of the present disclosure. The control logic 500 determines if a particular binary variable contributes to a high score in the trained logistic regression model. The process may be repeated for all significant binary input variables in the model. As illustrated in the flowchart, the control logic 500 includes the steps of scoring input data variables at step 501, picking a particular data variable (say, variable1) at step 502, and determining if the particular data variable is a binary data variable or not at step 503.

If the particular data variable is the binary data variable at step 503, then the control logic 500 includes the steps of extracting all data elements (i.e., samples) having a score greater than or equal to the pre-defined threshold score (say 0.7) at step 504, and computing various parameters with respect to the particular variable (i.e., variablel) at step 505. The parameters may include a percentage of samples (V1%) in the particular data variable having a value of 1, a percentage of samples (V2%) in the particular data variable having a value of 0, and a difference (D%) between the two percentages (V1%−V2%). The control logic 500 further includes the step determining if the difference (D%) is greater than or equal to a predefined threshold percentage (say 10%) at step 506.

If the difference (D%) is greater than or equal to the predefined threshold percentage at step 506, then the control logic 500 includes the step determining that all samples in the particular data variable having a value of 1 contributes to the high score at step 507. However, if the difference (D%) is not greater than or equal to the predefined threshold percentage at step 506, then the control logic 500 determines if the difference (D%) is less than or equal to a predefined threshold percentage (say−10%) at step 508. If the difference (D%) is less than or equal to the predefined threshold percentage at step 508, then the control logic 500 includes the step determining that all samples in the particular data variable having a value of 0 contributes to the high score at step 509. However, if the difference (D%) is not less than or equal to the predefined threshold percentage at step 508, then the control logic 500 includes the step determining that result in inconclusive at step 510.

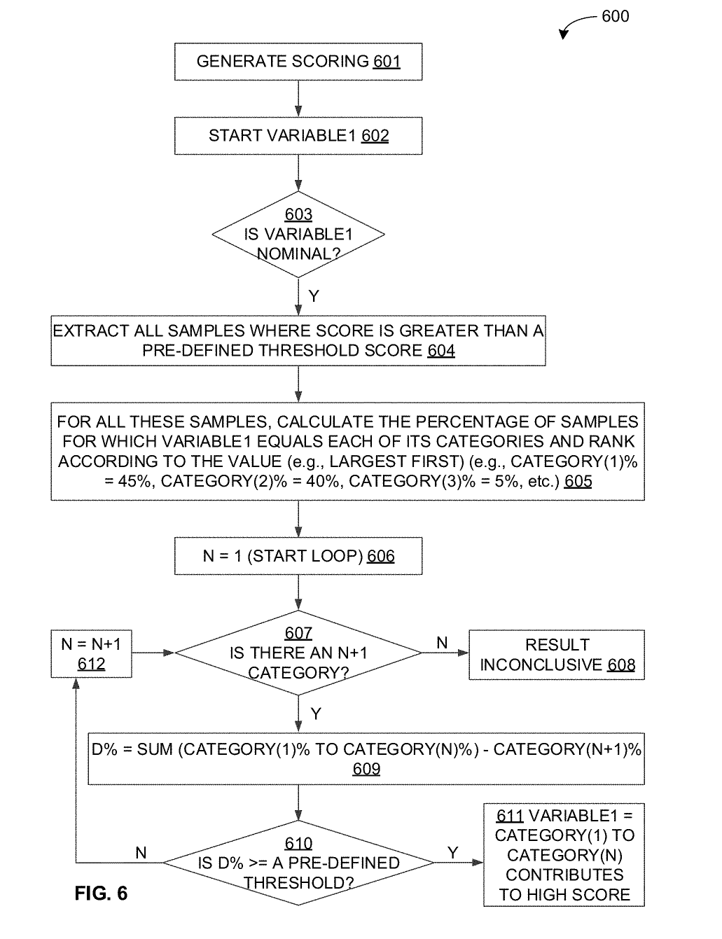

Referring now to FIG. 6, exemplary control logic 600 for categorizing categorical or nominal variables is depicted in greater detail via a flowchart in accordance with some embodiments of the present disclosure. The control logic 600 determines if a particular categorical or nominal variable contributes to a high score in the trained logistic regression model. The process may be repeated for all significant categorical or nominal input variables in the model. As illustrated in the flowchart, the control logic 600 includes the steps of scoring input data variables at step 601, picking a particular data variable (say, variablel) at step 602, and determining if the particular data variable is a categorical or a nominal data variable or not at step 603.

If the particular data variable is the categorical or the nominal data variable at step 603, then the control logic 600 includes the steps of extracting all data elements (i.e., samples) having a score greater than or equal to the pre-defined threshold score (say 0.7) at step 604, and computing the percentage of samples for which the particular variable equals each of its categories and ranking them according to the value (e.g., largest first) at step 605. For example, the categories may include catergory (1) comprising of 45% of samples, category(2) comprising of 40% of samples, and so forth. The categories may be extracted from the data variable. For example, if the variable is ‘color’ and the value for this variable may be one of a green, a blue, or a red, then the categories may be a green, a blue and a red.

The control logic 600 further includes the step starting an iterative process (with a variable n=1) at step 606 for a number of identified categories, and determining if there is an n+1 category at step 607. If there are no n+1 category, then the control logic 600 includes the step determining that result in inconclusive at step 608. However, if there are n+1 categories, then the control logic 600 includes the step determining a difference (D%) as cumulative sum of percentage of samples belonging to category(1) through percentage of samples belonging to category(n), and reduced by a percentage of samples belonging to category(n+1) at step 609. The control logic 600 further includes the step determining if the difference (D%) is greater than or equal to a predefined threshold percentage (say, 10%) at step 610. If the difference (D%) is greater than or equal to the predefined threshold percentage at step 610, then the control logic 600 includes the step of determining that all samples belonging to category(1) through category(n) contributes to the high score at step 611. However, if the difference (D%) is not greater than or equal to the predefined threshold percentage at step 610, then the control logic 600 includes the step of incrementing the value of n by 1 (i.e., n=n+1) at step 612. The control logic 600 then flows back to step 607.

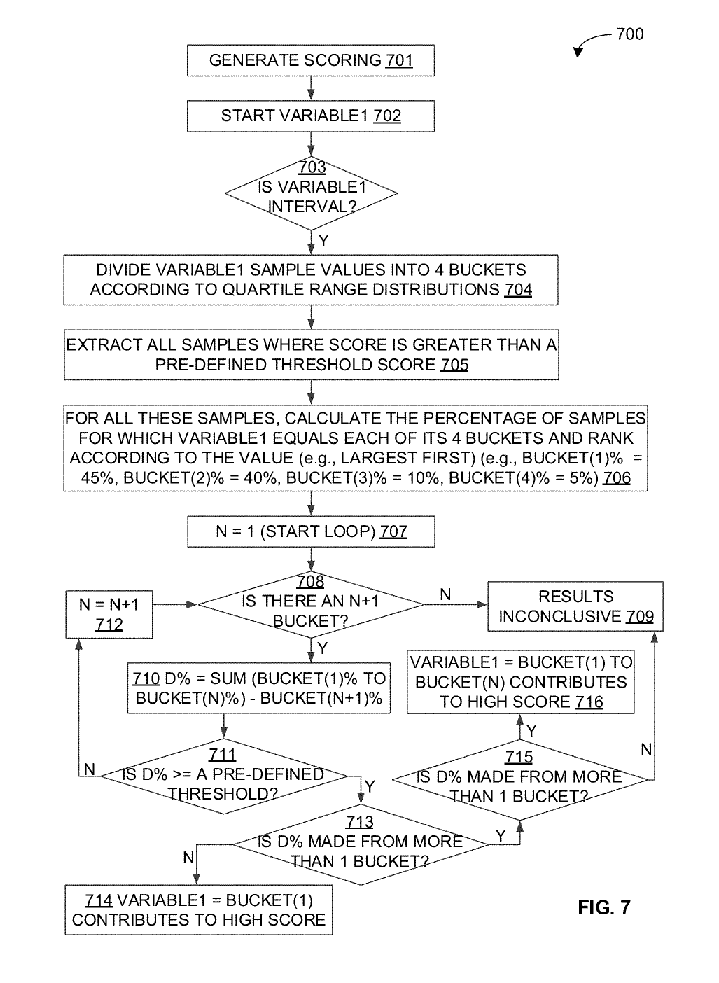

Referring now to FIG. 7, exemplary control logic 700 for categorizing interval or continuous variables is depicted in greater detail via a flowchart in accordance with some embodiments of the present disclosure. The control logic 700 determines if a particular interval or continuous variable contributes to a high score in the trained logistic regression model. The process may be repeated for all significant interval or continuous input variables in the model. As illustrated in the flowchart, the control logic 700 includes the steps of scoring input data variables at step 701, picking a particular data variable (say, variable1) at step 702, and determining if the particular data variable is an interval or a continuous data variable or not at step 703.

If the particular data variable is the interval or the continuous data variable at step 703, then the control logic 600 includes the step of dividing the samples of the particular data variable into four buckets according to quartile range distributions at step 704. The control logic 700 further includes the steps of extracting all data elements (i.e., samples) having a score greater than or equal to the pre-defined threshold score (say 0.7) at step 705, and computing percentage of samples for which the particular data variable equals each of its four buckets and ranking them according to the value (e.g., largest first) at step 706. In an embodiment, the buckets are divided up into quartile ranges where each range is based on collecting the next 25% of samples.

The control logic 700 further includes the step starting an iterative process (with a variable n=1) at step 707 for the number of buckets, and determining if there is an n+1 buckets at step 708. If there are no n+1 bucket, then the control logic 700 includes the step determining that result is inconclusive at step 709. However, if there are n+1 categories, then the control logic 700 includes the step determining a difference (D%) as cumulative sum of percentage of samples belonging to bucket(1) through percentage of samples belonging to bucket(n), and reduced by a percentage of samples belonging to bucket(n+1) at step 710. The control logic 700 further includes the step determining if the difference (D%) is greater than or equal to a predefined threshold percentage (say, 10%) at step 711. If the difference (D%) is not greater than or equal to the predefined threshold percentage at step 711, then the control logic 700 includes the step of incrementing the value of n by 1 (i.e., n=n+1) at step 712. The control logic 700 then flows back to step 708.

However, if the difference (D%) is greater than or equal to the predefined threshold percentage at step 711, then the control logic 700 includes the step of determining if the difference (D%) is made from more than 1 bucket at step 713. If the difference (D%) is not made from more than 1 bucket at step 713, then the control logic 700 includes the step of determining that all samples belonging to bucket(1) contributes to the high score at step 714. However, if the difference (D%) is made from more than 1 bucket at step 713, then the control logic 700 includes the step of determining if the buckets are adjacent to each other at step 715. If the buckets are adjacent to each other at step 715, then the control logic 700 includes the step of determining that all samples belonging to bucket(1) through bucket(n) contributes to the high score at step 716. However, if the buckets are not adjacent to each other at step 715, then the control logic 700 includes the step of determining that result is inconclusive as in step 709.

The primary objective of categorizing input variables in this way is to identify a threshold for each variable such that a value above or below the threshold is indicative of an increased probability of an output ‘high’ score. These thresholds may then be written as human-understandable rules that provide actionable insights in order to facilitate troubleshooting of what is potentially causing a high output score (also referred to as a failed state prediction).

In order to apply the above discussed logic to a trained neural network based predictive model, each hidden node in the neural network may be considered as a single linear logistic regression model where the output of the hidden node may be equivalent to the output score of the logistic regression model. Thus, a scorecard may be generated for every node in the neural network using the techniques described above. For example, a trained neural network with 10 hidden nodes may have 10 scorecards generated using the above described techniques. Further, within each scorecard every input will have its own rule. As will be appreciated, these scorecards and rules then provide the template for the rule activation and ranking module to select which scorecard and which rule is significant in the event that the overall neural network predicts a high output score.

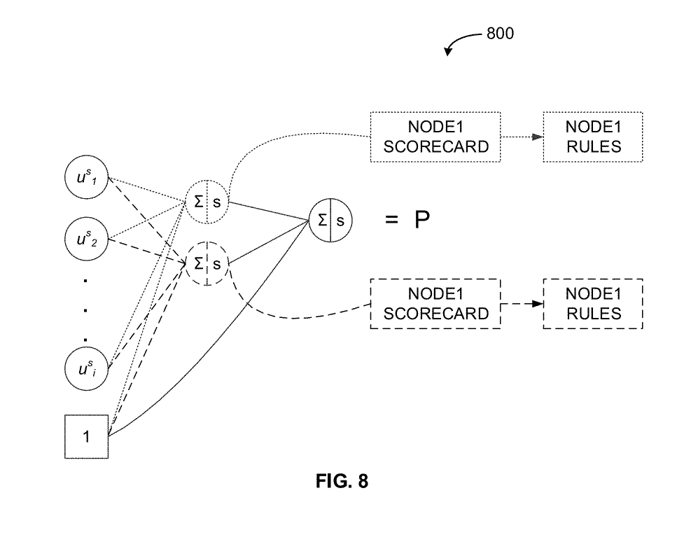

Referring now to FIG. 8, a schematic of neural network based predictive model 800 for generating scorecard rule table is illustrated in accordance with some embodiments of the present disclosure. The neural network based predictive model 800 comprises a number of input nodes (u₁^{E}, u₂^{S}, u₁^{S}) in in the input layer, at least one hidden node in at least one hidden layer, and an output node in an output layer. Each of the hidden nodes and the output nodes implements a sigmoidal activation function (s). An output score (P) of the neural network based predictive model predicts the target variable defect status from the input data variables. As discussed above, a scorecard may be generated for every node in the neural network such that within each scorecard every input will have its own rule. The scorecards (e.g., Nodel scorecard, Node2 scorecard, etc.) therefore corresponds to hidden nodes of the neural network, and each of the scorecards comprises a plurality of rules (e.g., Nodel rules, Node2 rules, etc.) corresponding to each input data variables.

Upon determination of scorecards using a trained neural network based predictive model, each input now has nₕ rules (where h is the number of hidden nodes in the model) that determine its individual contributions to each hidden node ‘firing’ or not. A node may be considered to have ‘fired’ if its output score (value) exceeds a pre-defined threshold. As stated above, different thresholds may be required for different types of application.

In order to present a parsimonious and relevant set of rules for any ‘fired’ state it may be necessary to determine which inputs are contributing (across all hidden nodes) to the current output state of the neural network. It is then necessary to calculate which node is most prominent in causing this state for that input and what is the associated rule for that input and that node. The result may be a list of the top few inputs that are implicated in causing the output of the overall neural network to ‘fire’ and the most relevant rules for those inputs given the current pattern of all input data values to the model. In other words, the moment a given set of input values causes the output of the neural network to ‘fire’ (i.e., to indicate a predicted failure), then the most relevant variables and rules may be provided to the activated rule selection and ranking module in order to facilitate root cause diagnostics.

In reference to equation (2), the individual contribution of each input to the output of the j^{th} hidden node is provided by equation (3), while the contribution of the bias term to the output of that node may be provided by equation (4) below:

$$\begin{matrix}{C}_{j} ( {u}_{i}^{s} ) = \frac{{( 1 + exp ( - {w}_{i , j} {u}_{i}^{s} ) )}^{- 1}}{{( 1 + exp ( - ( {β}_{j} + {Σ}_{i = 1}^{{n}_{i}} {w}_{i , j} {u}_{i}^{s} ) ) )}^{- 1}} & ( 3 ) \\ {C}_{j} ( {β}_{j} ) = \frac{{( 1 + exp ( - {β}_{j} ) )}^{- 1}}{{( 1 + exp ( - ( {β}_{j} + {Σ}_{i = 1}^{{n}_{i}} {w}_{i , j} {u}_{i}^{s} ) ) )}^{- 1}} & ( 4 )\end{matrix}$$

There are two issues that may arise from equations (3) and (4). Firstly, due to the sigmoidal nonlinearity, the sum of the individual contributions may exceed 100%. Secondly, a ‘zero’ contribution is potentially seen as significant (e.g. if a bias or input weight is zero) because the sigmoid of ‘zero’ equals 0.5 which may be close to the trigger threshold (e.g., 0.7). The first issue may be resolved by scaling the contributions such that their sum does equal 100%. The second issue may be resolved by scaling each input variable using normalization methods (e.g. subtract the mean and divide by the standard deviation). Equations (3) and (4) may therefore be scaled as follows:

$$\begin{matrix}{C}_{j}^{s} ( {u}_{i}^{s} ) = \frac{{C}_{j} ( {u}_{i}^{s} )}{{C}_{j} ( β ) + {Σ}_{i}^{{n}_{i}} {C}_{j} ( {u}_{i}^{s} )} & ( 5 ) \\ {C}_{j}^{z} ( {β}_{j} ) = \frac{{C}_{j} ( β )}{{C}_{j} ( β ) + {Σ}_{i}^{{n}_{i}} {C}_{j} ( {u}_{i}^{z} )} & ( 6 )\end{matrix}$$

The contribution of each input to the output of each hidden node may now be known, and may therefore be ranked. Further, the contribution of each hidden node output to the output of the overall neural network may be computed. This may be achieved using the same approach as that described for the input variables' contributions to the outputs of the hidden nodes. The unscaled contribution of the output of a particular hidden node may be provided by equation (7) below:

$${C}_{o} ( {O}_{j} ) = \frac{{( 1 + exp ( - {v}_{j} {O}_{j} ) )}^{- 1}}{{( 1 + exp ( - ( γ + {Σ}_{j = 1}^{{n}_{h}} {v}_{j} {O}_{j} ) ) )}^{- 1}} \qquad ( 7 )$$

In equation (7), Oⱼ is the output of the j^{th} hidden node, vⱼ is the weight between the j^{th} hidden node and the output node, and Y is the bias to the output node. The unscaled contribution of the bias to the output node may be provided by equation (8) below:

$${C}_{o} ( γ ) = \frac{{( 1 + exp ( - γ ) )}^{- 1}}{{( 1 + exp ( - ( γ + {Σ}_{j = 1}^{{n}_{h}} {v}_{j} {O}_{j} ) ) )}^{- 1}} \qquad ( 8 )$$

Again, the contributions provided by equations (7) and (8) may be scaled so that they sum to 100% as follows:

$$\begin{matrix}{C}_{O}^{s} ( {O}_{j} ) = \frac{{C}_{O} ( {O}_{j} )}{{C}_{O} ( γ ) + {Σ}_{j}^{{n}_{h}} {C}_{O} ( {O}_{j} )} & ( 9 ) \\ {C}_{O}^{s} ( γ ) = \frac{{C}_{O} ( γ )}{{C}_{O} ( γ ) + {Σ}_{j}^{{n}_{h}} {C}_{O} ( {O}_{j} )} & ( 10 )\end{matrix}$$

The overall contribution of an input uᵤ^{S} to the output score of the neural network may now be calculated as follows:

The inputs may therefore be ranked according to their contribution to the output score using equation (11). In circumstances where the output score exceeds a certain threshold (e.g. 0.7), the equation (11) may be used to display the top n variables contributing to the high output score. In order to extract the relevant rule to display for each variable, the individual components of equation (11) (i.e. (Cⱼ^{E}uᵢ^{s})C_{O}^{S}9Oⱼ)) may be used to rank the importance of each hidden node for that input's effect on the output score. The node with the largest value of (Cⱼ^{E}uᵢ^{s})C_{O}^{S}9Oⱼ)) may be the node from which the relevant rule should be taken for the input uᵢ^{s}, which may then be communicated to the activated rule selection and ranking module.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the technology. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the technology. When implemented on a general-purpose microprocessor, the computer program code segments configure the microprocessor to create specific logic circuits.

The disclosed methods and systems may be implemented on a conventional or a general-purpose computer system, such as a personal computer

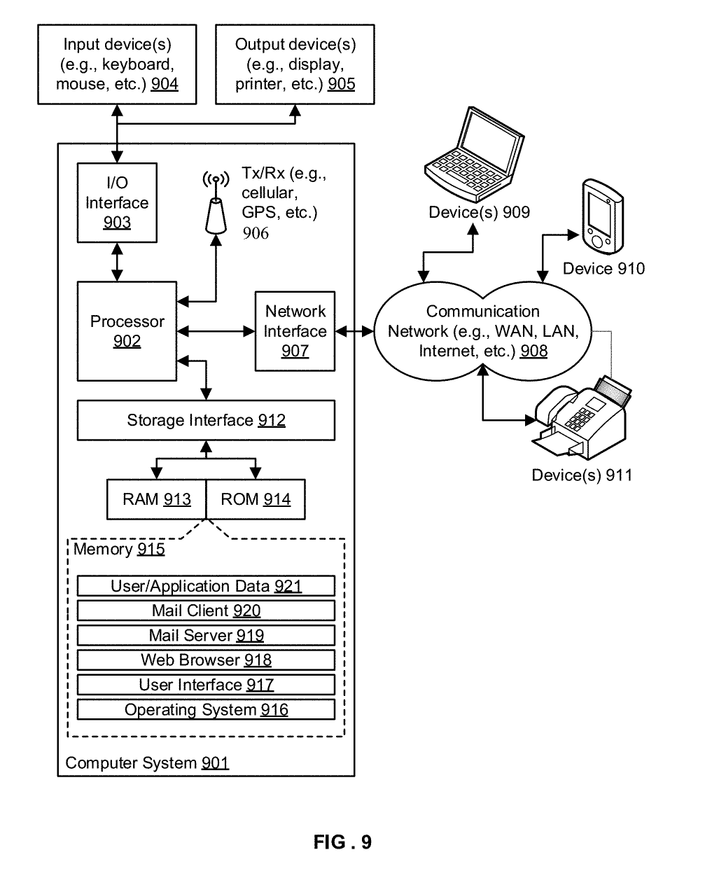

(PC) or server computer. Referring now to FIG. 9, a block diagram of an exemplary computer system 901 for implementing embodiments consistent with the present disclosure is illustrated. Variations of computer system 901 may be used for implementing system 100 and data mining engine 200 for mining data to generate actionable insights. Computer system 901 may comprise a central processing unit

(“CPU” or “processor”) 902. Processor 902 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 902 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 902 may be disposed in communication with one or more input/output (I/O) devices via I/O interface 903. The I/O interface 903 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 903, the computer system 901 may communicate with one or more I/O devices. For example, the input device 904 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 905 may be a printer, fax machine, video display (e.g., cathode ray tube (CRT), liquid crystal display (LCD), light-emitting diode (LED), plasma, or the like), audio speaker, etc. In some embodiments, a transceiver 906 may be disposed in connection with the processor 902. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 902 may be disposed in communication with a communication network 908 via a network interface 907. The network interface 907 may communicate with the communication network 908. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 908 may include, without limitation, a direct interconnection, local area network (LAN), wide area network (WAN), wireless network (e.g., using Wireless Application Protocol), the Internet, etc. Using the network interface 907 and the communication network 908, the computer system 901 may communicate with devices 909, 910, and 911. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 901 may itself embody one or more of these devices.

In some embodiments, the processor 902 may be disposed in communication with one or more memory devices (e.g., RAM 913, ROM 914, etc.) via a storage interface 912. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 916, user interface application 917, web browser 918, mail server 919, mail client 920, user/application data 921 (e.g., any data variables or data records discussed in this disclosure), etc. The operating system 916 may facilitate resource management and operation of the computer system 901. Examples of operating systems include, without limitation, Apple Macintosh OS X, Unix, Unix-like system distributions (e.g., Berkeley Software Distribution (B SD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 917 may facilitate display, execution, interaction, manipulation, or operation of program components through textual or graphical facilities. For example, user interfaces may provide computer interaction interface elements on a display system operatively connected to the computer system 901, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 901 may implement a web browser 918 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 901 may implement a mail server 919 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObj ects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 901 may implement a mail client 920 stored program component. The mail client may be a mail viewing application, such as Apple Mail, Microsoft Entourage, Microsoft Outlook, Mozilla Thunderbird, etc.

In some embodiments, computer system 901 may store user/application data 921, such as the data, variables, records, etc. (e.g., input data, target data, training data, predictive model, scores, score order, classification of data variables, categorization of data variables, scorecard rule table, defects, significant scorecard, significant rule, pre-defined thresholds, root cause analysis for the defects, actionable insights, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide an improved mechanism for accurately predicting defects along with its root causes in a timely manner, while providing contextualized, reliable and actionable recommendations with minimal false alarm for taking corrective measures on time. In some embodiments, the techniques described above accurately predicts component defects in manufacturing operations, and provide actionable recommendations for engineers and operators in order to facilitate an improvement in production yield. The accurate prediction of defects may be enabled by leveraging unadulterated, universal predictive modeling technology for highly accurate predictions. Additionally, actionable recommendations may be enabled by extracting human-understandable rules from these unadulterated predictive models in real-time that may be used for troubleshooting root causes of the defects.

The techniques described in the embodiments discussed above therefore provide a general mechanism to extract ranked, human understandable rules directly from a more accurate neural network based predictive model with reasonable speed and whilst maintaining overall accuracy of the prediction model for the purpose of performing root cause analysis and generating prescriptive information (i.e., actionable insights). The techniques described above use the neural network directly to select extracted rules on a case by case basis and do not approximate the neural network with a set of rules. Additionally, such analysis may triggered and performed with desired accuracy within reasonable time for being actionable.

Further, as will be appreciated by those skilled in the art, existing techniques are subject to a trade-off between accuracy of prediction and ease of use.

As stated above, highly accurate techniques such as those based on neural networks and deep learning algorithms are ‘black boxes’ which are difficult if not impossible to interpret and extract meaningful insight on. In contrast, easier to use techniques such as decision-trees are easy to understand but fail to predict with the same level of accuracy as neural networks. The techniques described in various embodiments discussed above uniquely addresses this trade-off. The techniques described in embodiments discussed above provide the same accuracy as a neural network (because it uses a neural network to make its predictions) but directly extracts the meaningful and easy to understand insights from the same (which otherwise is normally associated with a decision tree) without any loss of accuracy.

Moreover, the techniques described in the various embodiments discussed above are applicable to any neural network without placing any restrictions on how the model is trained so as to maintain the full approximating capability (accuracy) of the model. Many of the existing techniques that employs neural network based predictive model restricts the analysis to binary (fail or not fail) outcome based defect prediction so as to facilitate recommendation (problem rule extraction). As will be appreciated, such restriction is less accurate. Further, existing techniques perform ranking of extracted rules and thresholds (from binary outcome based model) in order to come up with actionable insights with the context of the manufacturing process in a language understandable by the user (operator/engineer). However, it is likely to lead to false prediction and incorrect recommendations as the rules are less accurate.

Thus, as will be appreciated, neural networks are powerful and accurate predictive models, but at the same time are complex ‘black boxes’ that yield no insights into why they are predicting what they are predicting. The techniques described above, extract human understandable rules from neural networks without impacting the integrity or accuracy of the model. Further, the techniques described above does not approximate the neural network model (thereby decreasing its accuracy) nor does it constrain the neural network in any way during training (again, which would decrease its accuracy). Thus, the techniques described above maintain complete accuracy of neural network model but still facilitates the extraction of human understandable rules from it.

The specification has described system and method for mining data to generate actionable insights. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for mining data to generate actionable insights, the method comprising:
receiving, by a data mining computing device, input data and target data from one or more sources;
detecting, by the data mining computing device, a defect in the target data using a predictive model based on a neural network and a scorecard rule table, wherein the scorecard rule table comprises a plurality of scorecards corresponding to a plurality of nodes of the neural network, and wherein each of the plurality of scorecards comprises a plurality of rules corresponding to a plurality of data variables in the input data;
determining, by the data mining computing device, at least one root cause for the defect by determining at least one significant scorecard of the plurality of scorecards and at least one significant rule in the at least one significant scorecard that contributed to the detection of the defect; and
generating, by the data mining computing device, one or more actionable insights based on the at least one root cause.

2. The method of claim 1, wherein the neural network comprises a self-learning neural network comprising at least one hidden layer comprising at least one hidden node and each of the plurality of scorecards corresponds to a hidden node in the at least one hidden layer of the neural network.

3. The method of claim 1, wherein the predictive model comprises a linear sum of a plurality of logistic regression models and an output layer comprising at least one output node.

4. The method of claim 1, further comprising training, by the data mining computing device, the predictive model using training data comprising a plurality of training data variables.

5. The method of claim 1, further comprising generating, by the data mining computing device, the scorecard rule table by:
generating a score, from the predictive model, for each of a plurality of data elements for each of the plurality of data variables;
determining a score order for each of the plurality of data elements for each of the plurality of data variables based on the corresponding score;
classifying each of the plurality of data variables into one of a binary data variable, a nominal data variable, and a continuous data variable;
categorizing the plurality of data variables based on the classification and the corresponding values; and
generating the scorecard rule table based on the classification, the score order, and the categorization.

6. The method of claim 1, wherein detecting the defect comprises determining when a score for an output parameter of the predictive model is greater than a pre-defined threshold and the determining the at least one root cause comprises determining the at least one significant scorecard of the plurality of scorecards and the at least one significant rule in the at least one significant scorecard that contributed in the score being greater than the pre-defined threshold.

7. The method of claim 1, wherein the at least one significant scorecard of the plurality of scorecards and the at least one significant rule in the at least one significant scorecard is determined from a plurality of coefficients of the predictive model.

8. A data mining computing device, comprising at least one processor and a memory having stored thereon instructions that, when executed by the at least one processor, cause the at least one processor to perform steps comprising:
receiving input data and target data from one or more sources;
detecting a defect in the target data using a predictive model based on a neural network and a scorecard rule table, wherein the scorecard rule table comprises a plurality of scorecards corresponding to a plurality of nodes of the neural network, and wherein each of the plurality of scorecards comprises a plurality of rules corresponding to a plurality of data variables in the input data;
determining at least one root cause for the defect by determining at least one significant scorecard of the plurality of scorecards and at least one significant rule in the at least one significant scorecard that contributed to the detection of the defect; and
generating one or more actionable insights based on the at least one root cause.

9. The data mining computing device of claim 8, wherein the neural network comprises a self-learning neural network comprising at least one hidden layer comprising at least one hidden node and each of the plurality of scorecards corresponds to a hidden node in the at least one hidden layer of the neural network.

10. The data mining computing device of claim 8, wherein the predictive model comprises a linear sum of a plurality of logistic regression models and an output layer comprising at least one output node.

11. The data mining computing device of claim 8, wherein the instructions, when executed by the at least one processor, further cause the at least one processor to perform one or more additional steps comprising training the predictive model using training data comprising a plurality of training data variables.

12. The data mining computing device of claim 8, wherein the instructions, when executed by the at least one processor, further cause the at least one processor to perform one or more additional steps comprising generating the scorecard rule table by:
generating a score, from the predictive model, for each of a plurality of data elements for each of the plurality of data variables;
determining a score order for each of the plurality of data elements for each of the plurality of data variables based on the corresponding score;
classifying each of the plurality of data variables into one of a binary data variable, a nominal data variable, and a continuous data variable;
categorizing the plurality of data variables based on the classification and the corresponding values; and
generating the scorecard rule table based on the classification, the score order, and the categorization.

13. The data mining computing device of claim 8, wherein detecting the defect comprises determining when a score for an output parameter of the predictive model is greater than a pre-defined threshold and the determining the at least one root cause comprises determining the at least one significant scorecard of the plurality of scorecards and the at least one significant rule in the at least one significant scorecard that contributed in the score being greater than the pre-defined threshold.

14. The data mining computing device of claim 8, wherein the at least one significant scorecard of the plurality of scorecards and the at least one significant rule in the at least one significant scorecard is determined from a plurality of coefficients of the predictive model.

15. A non-transitory computer-readable medium having stored thereon instructions for mining data to generate actionable insights comprising executable code which, when executed by one or more processors, causes the one or more processors to perform steps comprising:
receiving input data and target data from one or more sources;
detecting a defect in the target data using a predictive model based on a neural network and a scorecard rule table, wherein the scorecard rule table comprises a plurality of scorecards corresponding to a plurality of nodes of the neural network, and wherein each of the plurality of scorecards comprises a plurality of rules corresponding to a plurality of data variables in the input data;
determining at least one root cause for the defect by determining at least one significant scorecard of the plurality of scorecards and at least one significant rule in the at least one significant scorecard that contributed to the detection of the defect; and
generating one or more actionable insights based on the at least one root cause.

16. The non-transitory computer-readable medium of claim 15, wherein the neural network comprises a self-learning neural network comprising at least one hidden layer comprising at least one hidden node and each of the plurality of scorecards corresponds to a hidden node in the at least one hidden layer of the neural network.

17. The non-transitory computer-readable medium of claim 15, wherein the predictive model comprises a linear sum of a plurality of logistic regression models and an output layer comprising at least one output node.

18. The non-transitory computer-readable medium of claim 15, wherein the executable code, when executed by the one or more processors, further cause the one or more processors to perform one or more additional steps comprising training the predictive model using training data comprising a plurality of training data variables.

19. The non-transitory computer-readable medium of claim 15, wherein the executable code, when executed by the one or more processors, further cause the one or more processors to perform one or more additional steps comprising generating the scorecard rule table by:
generating a score, from the predictive model, for each of a plurality of data elements for each of the plurality of data variables;
determining a score order for each of the plurality of data elements for each of the plurality of data variables based on the corresponding score;
classifying each of the plurality of data variables into one of a binary data variable, a nominal data variable, and a continuous data variable;
categorizing the plurality of data variables based on the classification and the corresponding values; and
generating the scorecard rule table based on the classification, the score order, and the categorization.

20. The non-transitory computer-readable medium of claim 15, wherein detecting the defect comprises determining when a score for an output parameter of the predictive model is greater than a pre-defined threshold and the determining the at least one root cause comprises determining the at least one significant scorecard of the plurality of scorecards and the at least one significant rule in the at least one significant scorecard that contributed in the score being greater than the pre-defined threshold.

21. The non-transitory computer-readable medium of claim 15, wherein the at least one significant scorecard of the plurality of scorecards and the at least one significant rule in the at least one significant scorecard is determined from a plurality of coefficients of the predictive model.
